(19) United States
(12) Patent Application Publication
(10) Pub. No.: US 2017/0169919 A1
(43) Pub. Date: Jun. 15, 2017

(54) WIRE HARNESS AND METHOD FOR MANUFACTURING SAME

(71) Applicant: SUMITOMO WIRING SYSTEMS, LTD., Mie (JP)

(72) Inventors: Masataka WAKABAYASHI, Mie (JP); Tetsuro SUGINO, Mie (JP)

(73) Assignee: SUMITOMO WIRING SYSTEMS, LTD., Mie (JP)

(21) Appl. No.: 15/361,780

(22) Filed: Nov. 28, 2016

(30) Foreign Application Priority Data
Dec. 14, 2015 (JP) 2015-243381

(51) Int. Cl. H01B 7/282; B60R 16/02; H01B 13/012; H01B 7/00; H01B 7/285

(52) U.S. Cl. CPC H01B 7/2825; H01B 7/0045; H01B 7/285; H01B 13/01209; B60R 16/0207

(57) ABSTRACT

Provided are a wire harness that can facilitate the operations for performing waterproofing processing using a heat-shrinkable tube and the like on a connection portion where exposed conductor portions are connected, while also making it possible to reliably perform the waterproofing processing, and a method for manufacturing the wire harness. A wire harness includes coated electric wires that have exposed conductor portions obtained by removing portions of coatings and are arranged such that the exposed conductor portions are close to each other, a heat-shrinkable tube that surrounds the exposed conductor portions and adjacent end portions of the coatings, a splicing terminal that is integrally held in the heat-shrinkable tube and is close to the exposed conductor portions, and a soft brazing material that solidifies in a state in which voids between the splicing terminal and the exposed conductor portions are filled with the soft brazing material.

### CROSS-REFERENCE TO RELATED APPLICATIONS

The present application claims priority under 35 U.S.C. §119 of Japanese Application No. 2015-243381, filed on Dec. 14, 2015, the disclosure of which is expressly incorporated by reference herein in its entirety.

### TECHNICAL FIELD

The present invention relates to a wire harness and a method for manufacturing the wire harness, and particularly to a wire harness having a waterproofed spliced connection portion and a method for manufacturing the wire harness.

### BACKGROUND ART

In wire harnesses to be mounted in vehicles and the like, in many cases, coatings of coated electric wires are partially stripped to expose core wires made of a conductor, and other electric wires are connected to these exposed conductor portions. However, when these connection portions are arranged in areas exposed to water, it is required that the connection portions are reliably waterproofed. In addition, it is desirable that water can be stopped in order to prevent electric circuit connecting portions from being secondarily exposed to water that infiltrates toward the control circuit connecting portion and the device electric circuit connecting portion through the voids between strands of the core wires due to capillary action or the like.

In this type of conventional waterproofed wire harness, typically, as shown in FIG. 8, for example, a exposed conductor portion 1a located at an intermediate portion of one coated electric wire 1 and a exposed conductor portion 2a located at an end portion of another coated electric wire 2 are arranged to be adjacent to each other, and a splicing terminal 3 is crimped thereto to form a spliced portion 4 in which the coated electric wires 1 and 2 are spliced together. Then, a heat-shrinkable tube 5 (heat-adhesive tube) in which a hot melt material or the like is arranged on the inner circumferential side is arranged so as to surround the periphery of the spliced portion 4, and is heated. Thus, the heat-shrinkable tube 5 is thermally shrunk, and the hot melt material inside the heat-shrinkable tube 5 adheres to the spliced portion 4.

Conventionally, it has been known that when a heat-shrinkable tube with a hot melt material sheathes an intermediate spliced portion to which a splicing terminal has been crimped, a part of another heat-shrinkable tube is put over the end portion on the large diameter side of the aforementioned heat-shrinkable tube in order to suppress a shift of the heat-shrinkable tube from the large diameter side to the small diameter side of the coupling portion, that is, a milk-off phenomenon (see JP 2000-500405A, for example).

Furthermore, it has been known that a tubular body constituted by braided conductive strands and a solder sheet that covers the inner circumference of the tubular body are provided inside a heat-shrinkable tube, and two exposed conductor portions are inserted into the heat-shrinkable tube from respective ends thereof and connected to each other without a crimping terminal (see JP H7-142100A, for example).

JP 2000-500405A and JP H7-142100A are examples of related art.

However, in a conventional wire harness having an intermediate spliced portion to which a splicing terminal has been crimped and a method for manufacturing the wire harness, it is necessary to insert a coated electric wire in which a exposed conductor portion is formed at the intermediate position thereof into a heat-shrinkable tube from its one end in advance, and therefore, there is a problem in that it is not easy to waterproof the spliced portion.

Moreover, in a conventional wire harness having a connection portion in which a tubular body constituted by braided conductive strands is arranged inside a heat-shrinkable tube and a method for manufacturing the wire harness, the tubular body is constituted by the braided conductive strands and a solder sheet, and therefore, there is a problem in that it is difficult to reliably perform waterproofing processing.

That is, in conventional wire harnesses and methods for manufacturing the wire harness, it is difficult to facilitate the operations for connecting a plurality of coated electric wires at their exposed conductor portions and performing waterproofing processing using a heat-shrinkable tube or the like, while also reliably performing the waterproofing processing.

### SUMMARY OF THE INVENTION

The present invention was achieved in order to solve such conventional problems, and it is an object thereof to provide a wire harness that can facilitate the operations for performing waterproofing processing using a heat-shrinkable tube or the like on a connection portion where a plurality of exposed conductor portions are connected, while also making it possible to reliably perform the waterproofing processing, and a method for manufacturing the wire harness.

In order to achieve the aforementioned object, a wire harness according to an aspect of the present invention includes: a plurality of coated electric wires that have a plurality of exposed conductor portions obtained by removing portions of coatings and are arranged such that the exposed conductor portions are close to each other; a heat-shrinkable tube that surrounds the plurality of exposed conductor portions and end portions of the coatings of the plurality of coated electric wires, the end portions being adjacent to the exposed conductor portions; a splicing terminal having a substantially tubular shape that has an outer circumferential surface portion that is integrally held on an inner circumferential side of the heat-shrinkable tube and an inner circumferential surface portion that is close to the plurality of exposed conductor portions; and a soft brazing material that solidifies in a state in which voids between the splicing terminal and the plurality of exposed conductor portions are filled with the soft brazing material, wherein a liquidus temperature of the soft brazing material and a heat resistance temperature of the coatings of the plurality of coated electric wires are set such that the liquidus temperature is lower than or equal to the heat resistance temperature, and the splicing terminal and the soft brazing material integrally form a connecting member having a closed-ended tubular shape that accommodates the plurality of exposed conductor portions and the end portions of the coatings of the plurality of coated electric wires.

Therefore, in this aspect of the present invention, the connections between the splicing terminal and the exposed conductor portions are sufficiently secured via the broad joint surfaces of the soft brazing material, and the state of the connection via the soft brazing material is stably maintained by the splicing terminal having a substantially tubular shape. Furthermore, joining using the soft brazing material can be performed at a melting point lower than or equal to the heat resistance temperature of the coating, and the connecting member having a closed-ended tubular shape that accommodates not only the exposed conductor portions but also the end portions of the coatings of the coated electric wires is formed, thus making it possible to improve the waterproofing property.

A wire harness according to another aspect of the present invention can be configured such that the plurality of coated electric wires include a first coated electric wire in which a first exposed conductor portion among the plurality of exposed conductor portions is formed at an intermediate portion, and a second coated electric wire in which a second exposed conductor portion among the plurality of exposed conductor portions is formed at one end portion, and the first exposed conductor portion is bent substantially into a U shape.

In a wire harness according to yet another aspect of the present invention, it is preferable that the inner circumferential surface portion of the splicing terminal is provided with soft brazing material accommodating grooves that have a recess shape open toward an inner side in a radial direction and extend in a circumferential direction, at a plurality of positions in an axial direction.

On the other hand, a method for manufacturing a wire harness according to an aspect of the present invention includes steps of: preparing a plurality of coated electric wires having a plurality of exposed conductor portions obtained by removing portions of coatings, a heat-shrinkable tube that is long enough to accommodate the plurality of exposed conductor portions, a splicing terminal having a substantially tubular shape that can connect the plurality of exposed conductor portions, and a soft brazing material in a paste form with which voids between the splicing terminal and the plurality of exposed conductor portions can be filled and that melts at a melting point lower than a heat resistance temperature of the coatings of the plurality of coated electric wires; holding the splicing terminal integrally in the heat-shrinkable tube in advance by shrinking a portion of the heat-shrinkable tube; filling voids between the splicing terminal and the plurality of exposed conductor portions with the soft brazing material by adhering a predetermined amount of the soft brazing material to at least one out of an inner circumferential surface portion of the splicing terminal that is integrally held in the heat-shrinkable tube and the plurality of exposed conductor portions and then inserting the plurality of exposed conductor portions and end portions of the coatings of the plurality of coated electric wires into the splicing terminal integrally held in the heat-shrinkable tube, the end portions being adjacent to the exposed conductor portions; and heating the heat-shrinkable tube and the inside of the heat-shrinkable tube from outside of the heat-shrinkable tube to thermally shrink the heat-shrinkable tube and to form a connecting member having a closed-ended tubular shape using the splicing terminal and the soft brazing material, the connecting member accommodating the plurality of exposed conductor portions, while also connecting the splicing terminal and the plurality of exposed conductor portions via the soft brazing material.

With the method for manufacturing a wire harness according to the above aspect of the present invention, after the voids between the splicing terminal and the exposed conductor portions are filled with the soft brazing material by inserting the exposed conductor portions into the splicing terminal, heating is performed to thermally shrink the heat-shrinkable tube and to form the connecting member having a closed-ended tubular shape that accommodates the exposed conductor portions while also connecting the splicing terminal and the exposed conductor portions via the soft brazing material. Therefore, a broad range including the surroundings of the exposed conductor portions and the voids between the strands can be filled with the soft brazing material, and the end portions of the coatings can be covered with the soft brazing material. This makes it possible to facilitate the operations for performing waterproofing processing using the heat-shrinkable tube and the like on the connection portion where the exposed conductor portions are connected, and to reliably perform the waterproofing processing.

With the present invention, it is possible to provide a wire harness that can facilitate the operations for performing waterproofing processing using a heat-shrinkable tube and the like on a connection portion where a plurality of exposed conductor portions are connected, while also making it possible to reliably perform the waterproofing processing, and a method for manufacturing the wire harness.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a perspective view of a wire harness according to a first embodiment of the present invention in a state in which a sheath tube is not thermally shrunk yet;

FIG. 2 is a cross-sectional view of main portions of the wire harness in the state shown in FIG. 1;

FIG. 3 is an exploded perspective view of main portions of the wire harness according to the first embodiment of the present invention;

FIG. 4 is a longitudinal cross-sectional view of a splicing terminal in the wire harness according to the first embodiment of the present invention;

FIG. 5 is a diagram illustrating steps in the first half of a process for manufacturing the wire harness according to the first embodiment of the present invention;

FIG. 6 is a diagram illustrating steps in the second half of the process for manufacturing the wire harness according to the first embodiment of the present invention;

FIG. 7 is a diagram illustrating main portions during a process for manufacturing a wire harness according to a second embodiment of the present invention; and

FIG. 8 is a diagram illustrating a waterproofing process performed on a spliced portion of a conventional wire harness.

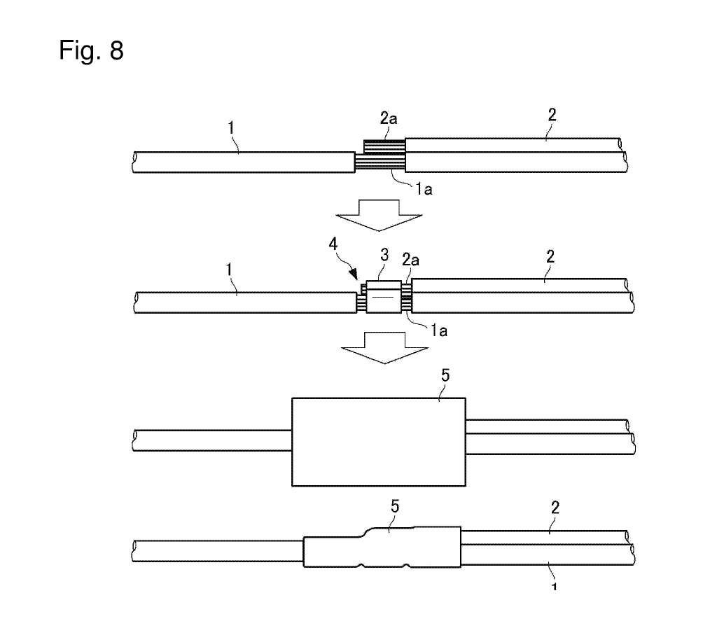

### EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice. Hereinafter, embodiments of the present invention will be described with reference to the drawings.

### First Embodiment

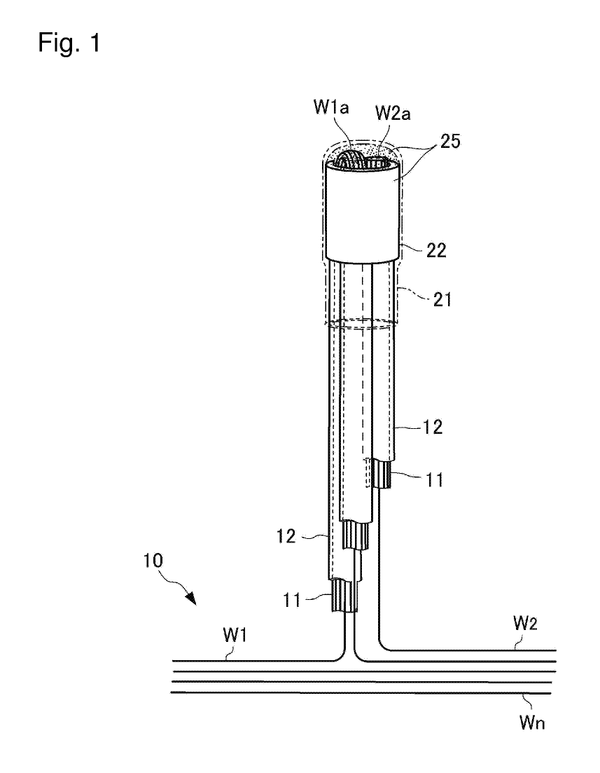

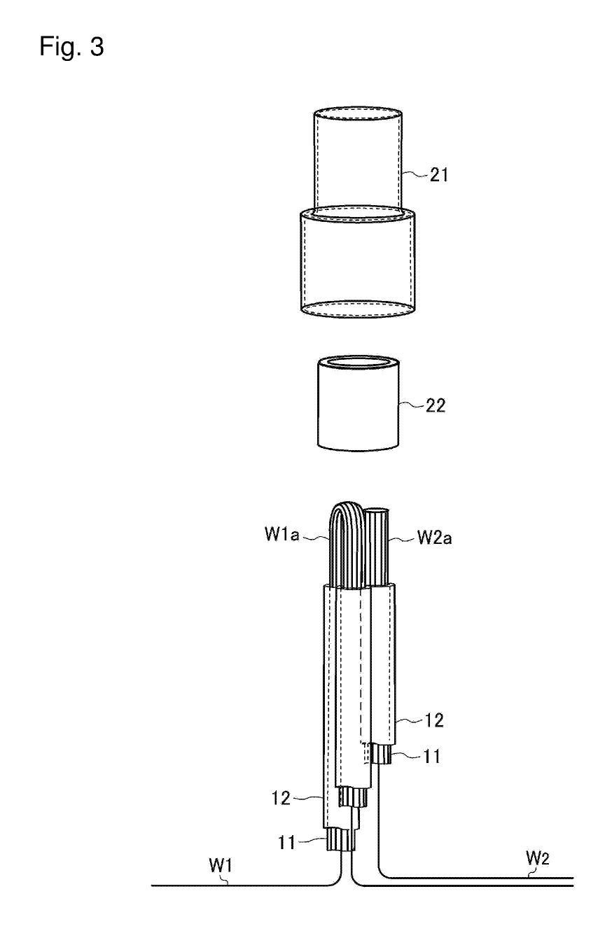

FIGS. 1 to 4 show an embodiment of a wire harness according to the present invention. This embodiment is a wire harness for a vehicle to which the present invention is applied, and has a configuration in which an intermediate portion of one coated electric wire and an end portion of another coated electric wire are spliced to each other.

First, the configuration of this embodiment will be described.

As shown in FIGS. 1 to 3, a wire harness 10 according to this embodiment includes a plurality of coated electric wires W1 to Wn (n is a natural number greater than or equal to 2) that are coated with an insulating coating, and the first coated electric wire W1 and the second coated electric wire W2 among these electric wires are each constituted by a core wire 11 including a plurality of strands (not shown) and a coating 12 surrounding the core wire 11 concentrically.

In the core wire 11, the strands are each constituted by an aluminum alloy wire, for example, but may be constituted by a soft conductive wire or made of another material. The coating 12, which is an insulating coating material, is made of a flame-retardant polyolefin-based resin, for example, but may be made of a resin that is mainly composed of a vinyl chloride resin, a fluoro-resin, or other resins.

A exposed conductor portion W1a (a portion separated from the two end portions) in the longitudinal direction of the first coated electric wire W1 and a exposed conductor portion W2a of the second coated electric wire W2 are arranged so as to be close to each other. Here, the exposed conductor portion W1a of the first coated electric wire W1 is a first exposed conductor portion obtained by removing a portion of the coating 12 to expose a portion of the core wire 11 in a portion (intermediate portion) separated from the two end portions of the coated electric wire W1, and the exposed conductor portion W2a of the second coated electric wire W2 of the coated electric wires is a second exposed conductor portion obtained by removing a portion of the coating 12 to expose a portion of the core wire 11 at one end portion of the coated electric wire W2.

The core wires 11 in the exposed conductor portions W1a and W2a of the coated electric wires W1 and W2 are brazed to each other in a state in which the exposed conductor portion W1a in the longitudinal direction of the coated electric wire W1 is bent substantially into a U shape, and the vicinity of the bent point of the substantially U-shaped exposed conductor portion W1a and the vicinity of the tip end of the substantially straight exposed conductor portion W2a of the coated electric wire W2 are adjacent to each other.

The exposed conductor portions W1a and W2a of the coated electric wires W1 and W2 and adjacent end portions 12a of the coatings 12 of the coated electric wires W1 and W2 are surrounded by a heat-shrinkable tube 21. It should be noted that the heat-shrinkable tube 21 is indicated by a virtual line in FIG. 1 for the sake of convenience in the description.

The heat-shrinkable tube 21 has a closed-ended tubular shape in which one end is closed, and the exposed conductor portions W1a and W2a of the coated electric wires W1 and W2 are inserted into the heat-shrinkable tube 21 from the other end side thereof. The heat-shrinkable tube 21 has a hot melt material layer (not shown) having a predetermined thickness on the inner circumferential surface side. A splicing terminal 22 having a substantially tubular shape is provided on the inner circumferential surface side of the heat-shrinkable tube 21. The splicing terminal 22 includes an outer circumferential surface portion 22a that is integrally held by the heat-shrinkable tube 21 and an inner circumferential surface portion 22b that is close to the exposed conductor portions W1a and W2a of the coated electric wires W1 and W2.

The splice terminal 22 is obtained by tinning the surface of a terminal base material having a substantially tubular shape that is made of a copper alloy, for example. This splicing terminal 22 is formed by punching out a predetermined shape from a tinned copper alloy plate and bending the resultant plate into a substantially tubular shape, for example, and has a plurality of recessed portions and projecting portions on the inner surface side (details will be described later).

A soft brazing material 23 that is a low melting solder is provided between the splicing terminal 22 and the exposed conductor portions W1a and W2a of the coated electric wires W1 and W2 such that the voids therebetween are filled with the soft brazing material 23.

The soft brazing material 23 and the coated electric wires W1 and W2 are selected such that the liquidus temperature of the soft brazing material 23 is lower than or equal to the heat resistance temperature (upper-limit temperature at which a required coating function can be retained) of the coatings 12 of the coated electric wires W1 and W2. The soft brazing material 23 includes a Sn—Bi based low melting lead-free solder (referred to as “bismuth solder” hereinafter), for example. Before brazing, this soft brazing material 23 is in a paste form and has a viscosity according to which the shape of the applied soft brazing material 23 can be maintained.

The splicing terminal 22 and the soft brazing material 23 integrally form a connecting member 25 having a closed-ended tubular shape that accommodates the exposed conductor portions W1a and W2a of the coated electric wires W1 and W2 and a plurality of (three in the diagrams) end portions 12a of the coatings 12 adjacent to the exposed conductor portions W1a and W2a.

Furthermore, the inner circumferential surface portion 22b of the splicing terminal 22 is provided with a plurality of soft brazing material accommodating grooves 22c that have a recess shape open toward the inner side in the radial direction and extend in the circumferential direction, at a plurality of positions in the axial direction of the substantially tubular shape. A plurality of projections 22d that each have a plurality of edges are formed between the soft brazing material accommodating grooves 22c. The projections 22d each have a parallel rib shape, for example, and can also be formed in another projection shape such as a screw thread shape, a truncated pyramid shape, a pyramid shape, or a lance shape.

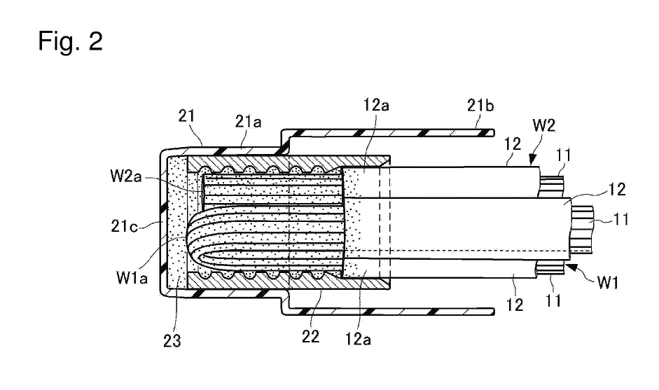

The soft brazing material accommodating grooves 22c are parallel grooves in which the cross section of the inner wall surface has an arc shape as shown in FIG. 2, and extend in the circumferential direction or in an inclined direction that intersects the circumferential direction at a predetermined angle, for example. If the splicing terminal 22 is not formed by being bent into a tubular shape and has no slit in the circumferential direction, the soft brazing material accommodating grooves 22c may be made up of one spiral groove or two spiral grooves that obliquely extend in directions opposed to each other and intersect each other.

The projections 22d are separated at least in the axial direction, e.g., in the axial direction and the circumferential direction, by the soft brazing material accommodating grooves 22c, and each of them has edges (corners) at the two lateral end portions adjacent to the soft brazing material accommodating grooves 22c.

The splicing terminal 22 is pressure-welded to the exposed conductor portions W1a and W2a of the coated electric wires W1 and W2 by a predetermined crimping load being applied, and the tin plating on the surface layer of the splicing terminal 22 is crimped to the surface layer portions of the core wires 11 at the edge portions of the projections 22d.

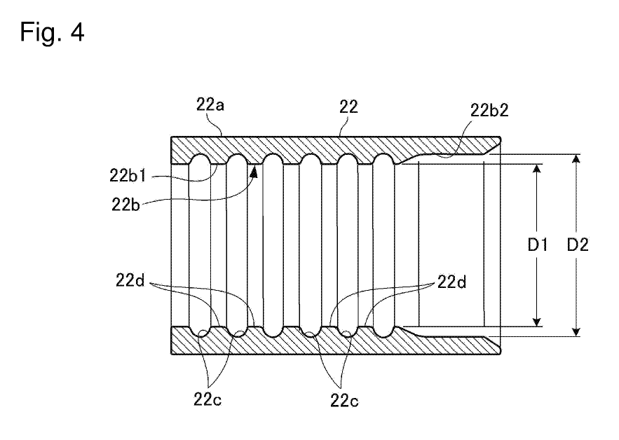

It should be noted that the soft brazing material accommodating grooves 22c and the projections 22d may be formed by forming recessed portions and projecting portions using conventionally known surface processing such as plastic deformation by partial pressure application etc., physical or chemical etching, or the like. In FIG. 4, an inner diameter D2 of an inner circumferential surface portion 22b2 of the splicing terminal 22 on the right end side in this diagram is larger than an inner diameter D1 of an inner circumferential wall surface portion 22b1 thereof on the left end side, but the inner circumferential surface portion may have the same diameter and the same recesses and projections as those of the inner circumferential wall surface portion 22b1 on the left end side, over the entire length.

Next, a method for manufacturing a wire harness according to an embodiment of the present invention will be described.

When the wire harness 10 according to this embodiment is manufactured, first, the coated electric wires W1 and W2 having the exposed conductor portions W1a and W2a that are obtained by removing a portion of the coatings 12, the unshrunk heat-shrinkable tube 21 that is long enough to accommodate the exposed conductor portions W1a and W2a, the splicing terminal 22 having a substantially tubular shape that can connect the exposed conductor portions W1a and W2a, and a pasty soft brazing material 23M with which the voids between the splicing terminal 22 and the exposed conductor portions W1a and W2a can be filled are prepared (preparation step).

The pasty soft brazing material 23M herein is obtained by mixing a small amount of pasty flux and low melting bismuth solder particles that start to melt at a melting point lower by a predetermined value than the heat resistance temperature (upper-limit temperature at which a function of the coating can be reliably exhibited) of the coatings 12 of the coated electric wires W1 and W2.

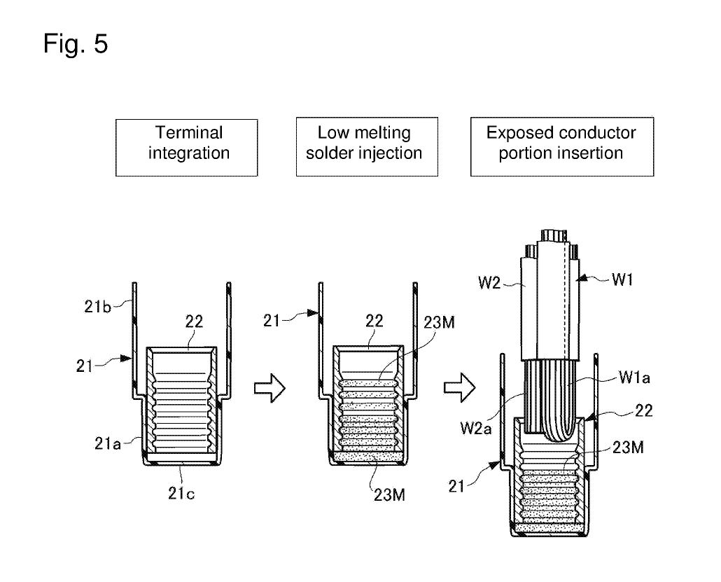

Next, as shown in the left diagram in FIG. 5, a circumferential wall portion 21a, which is a portion of the heat-shrinkable tube 21, on one end side is thermally shrunk in advance, and thus the splicing terminal 22 is integrally held in the heat-shrinkable tube 21 (“terminal integration” step in FIG. 5).

Next, as shown in the middle diagram in FIG. 5, a predetermined amount of the pasty soft brazing material 23M is adhered to at least one out of the inner circumferential surface portion 22b of the splicing terminal 22 and the exposed conductor portions W1a and W2a of the coated electric wires W1 and W2, e.g., the inner circumferential surface portion 22b of the splicing terminal 22 and the inner rear side of the heat-shrinkable tube 21 (“low melting solder injection” step in FIG. 5).

Thereafter, as shown in the right diagram in FIG. 5, the exposed conductor portions W1a and W2a of the coated electric wires W1 and W2 and the adjacent end portions 12a of the coatings 12 are inserted into the splicing terminal 22 inside the heat-shrinkable tube 21, and then the voids between the splicing terminal 22 and the exposed conductor portions W1a and W2a are filled with the pasty soft brazing material 23M (“exposed conductor portion insertion” step in FIG. 5).

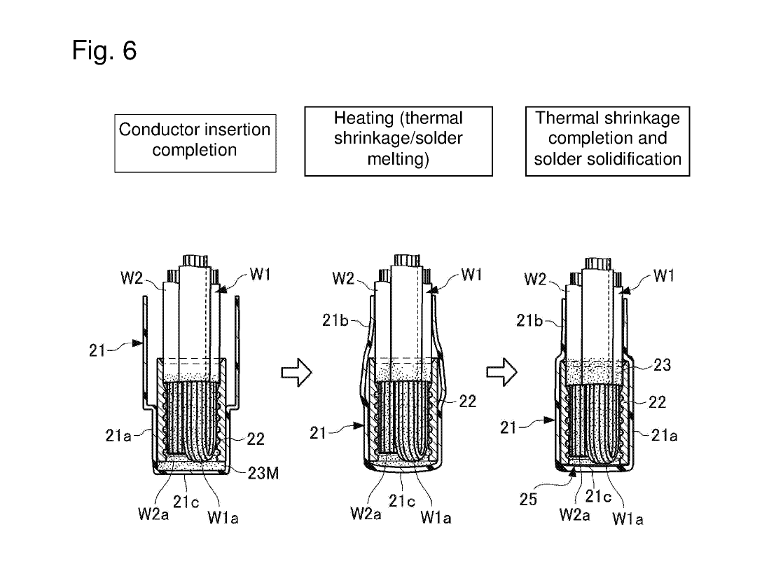

After the voids between the splicing terminal 22 and the exposed conductor portions W1a and W2a are filled with the pasty soft brazing material 23M in this manner as shown in the left diagram in FIG. 6 (“conductor insertion completion” step in FIG. 6), the heat-shrinkable tube 21 and the inside thereof are heated from the outside of the heat-shrinkable tube 21 as shown in the middle diagram in FIG. 6 (“heating (thermal shrinkage/solder melting)” step in FIG. 6).

At this time, a large-diameter portion 21b and the vicinity of an inner bottom wall portion 21c of the heat-shrinkable tube 21 are thermally shrunk, whereas when the temperature of the inside of the heat-shrinkable tube 21 rises to the melting point of the bismuth solder in the pasty soft brazing material 23M or higher, the solder starts to melt, and when the temperature rises to the liquidus temperature, the inner circumferential surface portion 22b of the splicing terminal 22 and the exposed conductor portions W1a and W2a of the coated electric wires W1 and W2 are brazed to each other with the bismuth solder.

Then, when the heat-shrinkable tube 21 is sufficiently heated to reach a predetermined shrinkage state, the inner circumferential surface portion (hot melt material layer) of the heat-shrinkable tube 21 comes into close contact with the portions of the coated electric wires W1 and W2 that are adjacent to the end portions 12a of the coatings 12, and the bismuth solder solidifies into the soft brazing material 23 as shown in the right diagram in FIG. 6. Thereby, the splicing terminal 22 and the soft brazing material 23 form the connecting member 25 having a closed-ended tubular shape that integrally accommodates the exposed conductor portions W1a and W2a of the coated electric wires W1 and W2.

Before or after performing this heating step, a predetermined crimping load is applied to a portion of the splicing terminal 22, and thus the splicing terminal 22 is pressure-welded to the exposed conductor portions W1a and W2a of the coated electric wires W1 and W2, and the surface layer portions (tinned portions) of the edge portions of the projections 22d of the splicing terminal 22 are crimped to the surface layer portions of the core wires 11.

Next, the effects will be described.

In the wire harness 10 according to this embodiment configured as described above, the connections between the splicing terminal 22 and the exposed conductor portions W1a and W2a of the coated electric wires W1 and W2 are sufficiently secured via the broad joint surfaces of the soft brazing material 23, and the state of the connection between the splicing terminal 22 and the exposed conductor portions W1a and W2a via the soft brazing material 23 is stably maintained by the splicing terminal 22 having a substantially tubular shape.

Furthermore, brazing using the soft brazing material 23 is performed at a temperature lower than or equal to the heat resistance temperature of the coatings 12, and the connecting member 25 having a closed-ended tubular shape that accommodates not only the exposed conductor portions W1a and W2a of the coated electric wires W1 and W2 but also the end portions 12a of the coatings 12 of the coated electric wires W1 and W2 is formed, and therefore, the opening end side of the heat-shrinkable tube 21 is reliably sealed around the end portions 12a of the coatings 12 of the coated electric wires W1 and W2, thus making it possible to improve the waterproofing property.

In addition, in this embodiment, the exposed conductor portion W1a located at an intermediate portion of the coated electric wire W1 is bent substantially into a U shape and accommodated in the cap-shaped heat-shrinkable tube 21, and therefore, it is not necessary to insert a long coated electric wire into a heat-shrinkable tube in advance in order to form an intermediate spliced portion, thus making it possible to facilitate the splicing operation.

Moreover, in this embodiment, the inner circumferential surface portion 22b of the splicing terminal 22 has the soft brazing material accommodating grooves 22c extending in the circumferential direction at a plurality of positions in the axial direction, and therefore, an appropriate amount of the pasty soft brazing material 23M is arranged in the entire region in the circumferential direction on the inner circumferential surface side of the splicing terminal 22 on which the above-described heating step has not been performed yet, and even the void around the end portions 12a of the coatings 12 of the coated electric wires W1 and W2 can be effectively filled with the pasty soft brazing material 23M in the exposed conductor portion insertion step. Furthermore, since the edge portions of the projections 22d are crimped to the surface layer portions of the core wires 11 at a large number of positions, corrosion can be prevented by securing the above-described waterproofing property, and in addition to this, a stable electrical connection can be secured even in a case where aluminum electric wires are used.

In the method for manufacturing a wire harness according to this embodiment, the soft brazing material 23 is adhered to at least one out of the inner circumferential surface portion 22b of the splicing terminal 22 inside the heat-shrinkable tube 21 and the exposed conductor portions W1a and W2a in advance, and thus, when the exposed conductor portions W1a and W2a are inserted into the splicing terminal 22, the voids between the splicing terminal 22 and the exposed conductor portions W1a and W2a are filled with the soft brazing material 23. Then, heating is performed to thermally shrink the heat-shrinkable tube 21 and to form the connecting member 25 having a closed-ended tubular shape that accommodates the exposed conductor portions W1a and W2a together with the end portions 12a of the coatings 12 while also connecting the splicing terminal 22 and the exposed conductor portions W1a and W2a via the soft brazing material 23

Therefore, a broad range including the surroundings of the exposed conductor portions W1a and W2a and the voids between the strands can be filled with the soft brazing material 23, and the end portions 12a of the coatings 12 can be covered with the soft brazing material 23. This makes it possible to facilitate the operations for performing waterproofing processing using the heat-shrinkable tube 21 and the like on the connection portion where the exposed conductor portions W1a and W2a of the coated electric wires W1 and W2 are connected, and to reliably perform the waterproofing processing.

As described above, with this embodiment, it is possible to provide the wire harness 10 that facilitates the operations for performing waterproofing processing using a heat-shrinkable tube 21 and the like on a connection portion where the exposed conductor portions W1a and W2a are connected, while also making it possible to reliably perform the waterproofing processing, and the method for manufacturing the wire harness 10.

### Second Embodiment

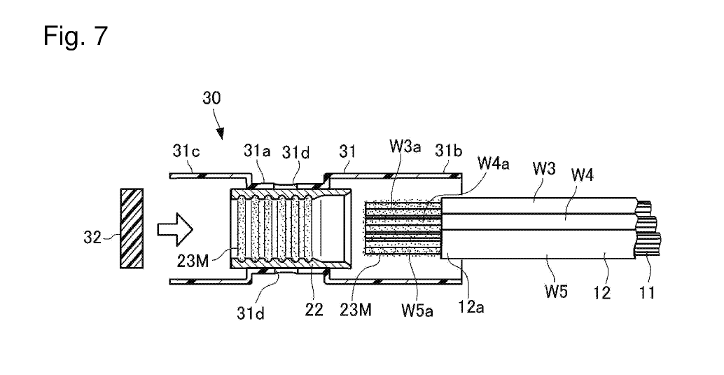

FIG. 7 shows main portions of a wire harness according to a second embodiment of the present invention in a state in which the heating step has not been performed yet. It should be noted that the embodiment described below differs from the above-described first embodiment with respect to the mode of the heat-shrinkable tube and the exposed conductor portions of the coated electric wires, but the other configurations are the same as or similar to those of the first embodiment. Therefore, hereinafter, components having configurations that are the same as or similar to those of the components described in the first embodiment are denoted by the same reference numerals as those of the corresponding components of the first embodiment shown in FIGS. 1 to 6, and the differences between the second embodiment and the first embodiment will be described.

In a wire harness 30 according to the second embodiment shown in FIG. 7, a heat-shrinkable tube 31 having two open ends and a plug member 32 that is made of a resin or metal, has a substantially circular plate shape, and can close one end of the heat-shrinkable tube 31 are provided instead of the heat-shrinkable tube 21 having a closed-ended cylindrical shape of the first embodiment.

Specifically, as shown in FIG. 7, after the heat-shrinkable tube 31 is heated so as to be partially shrunk and thus an intermediate portion 31a thereof is integrated with the splicing terminal 22 in advance, the plug member 32 is inserted into one end portion 31c of the heat-shrinkable tube 31 and thus located close to the splicing terminal 22, and then the one end portion 31c of the heat-shrinkable tube 31 is thermally shrunk. Accordingly, the heat-shrinkable tube 31 can be given a shape in which one end is closed and the other is open, similarly to the heat-shrinkable tube 21 of the first embodiment.

Coated electric wires W3, W4, and W5 respectively have exposed conductor portions W3a, W4a, and W5a on one end side, similarly to the coated electric wire W2 of the first embodiment. When the exposed conductor portions W3a, W4a, and W5a are inserted into the splicing terminal 22 in a state in which the pasty soft brazing material 23M has been adhered to the exposed conductor portions W3a, W4a, and W5a in advance, the voids between the splicing terminal 22 and the exposed conductor portions W3a, W4a, and W5a and between the splicing terminal 22 and the end portions 12a of the coatings 12 are filled with the pasty soft brazing material 23M.

Therefore, in this embodiment as well, the heating step can be performed to thermally shrink the heat-shrinkable tube 31 and to form a connecting member (no reference numeral) having a closed-ended tubular shape that accommodates the exposed conductor portions W3a, W4a, and W5a together with the three end portions 12a of the coatings 12 while also brazing the splicing terminal 22 and the exposed conductor portions W3a, W4a, and W5a.

Before or after performing this heating step, a predetermined crimping load is applied to a plurality of portions of the splicing terminal 22 through a plurality of opening portions 31d that are open at the intermediate portion 31a of the heat-shrinkable tube 31, and thus the splicing terminal 22 is pressure-welded to the exposed conductor portions W3a, W4a, and W5a of the coated electric wires W3, W4, and W5, and the surface layer portions (tinned portions) of the edge portions of the projections 22d of the splicing terminal 22 are crimped to the surface layer portions of the core wires 11.

Therefore, in this embodiment as well, a broad range including the surroundings of the exposed conductor portions W3a, W4a, and W5a and the voids between the strands can be filled with the soft brazing material 23, and the end portions 12a of the coatings 12 can be covered with the soft brazing material 23. This makes it possible to facilitate the operations for performing waterproofing processing using the heat-shrinkable tube 31 and the like on the connection portion where the exposed conductor portions W3a, W4a, and W5a of the coated electric wires W3, W4, and W5 are connected, and to reliably perform the waterproofing processing.

Although the splicing terminal 22 is formed in a substantially cylindrical shape in the above-described embodiments, the splicing terminal 22 may have a cross section having a flattened shape such as a substantially elliptic (egg-shaped) shape or another non-circular shape. In this case, a surface against which the end surface of a material that is not bent yet or a slit may be arranged near the center in the longitudinal direction. Moreover, the plug member 32 may be made of the same metal as used for the splicing terminal 22, and recessed portions and projecting portions may be formed on the inner side of the plug member 32.

As described above, with the present invention, it is possible to provide a wire harness that can facilitate the operations for performing waterproofing processing and the like on a connection portion where a plurality of exposed conductor portions are connected, while also making it possible to reliably perform the waterproofing processing, and a method for manufacturing the wire harness. The present invention is useful for a wire harness having a waterproofed spliced connection portion and a method for manufacturing the wire harness in general.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A wire harness comprising:
a plurality of coated electric wires having a plurality of exposed conductor portions obtained by removing portions of coatings, and being arranged such that the exposed conductor portions are close to each other;
a heat-shrinkable tube surrounding the plurality of exposed conductor portions and end portions of the coatings of the plurality of coated electric wires, the end portions being adjacent to the exposed conductor portions;
a splicing terminal having a substantially tubular shape that has an outer circumferential surface portion integrally held on an inner circumferential side of the heat-shrinkable tube and an inner circumferential surface portion close to the plurality of exposed conductor portions; and
a soft brazing material solidified in a condition in which voids between the splicing terminal and the plurality of exposed conductor portions are filled with the soft brazing material,
wherein a liquidus temperature of the soft brazing material is lower than or equal to a heat resistance temperature of the coatings of the plurality of coated electric wires, and
the splicing terminal and the soft brazing material integrally form a connecting member having a closed-ended tubular shape that accommodates the plurality of exposed conductor portions and the end portions of the coatings of the plurality of coated electric wires.

2. The wire harness according to claim 1,
wherein the plurality of coated electric wires include a first coated electric wire in which a first exposed conductor portion among the plurality of exposed conductor portions is formed at an intermediate portion, and a second coated electric wire in which a second exposed conductor portion among the plurality of exposed conductor portions is formed at one end portion, and the first exposed conductor portion is bent substantially into a U shape.

3. The wire harness according to claim 1, wherein the inner circumferential surface portion of the splicing terminal includes soft brazing material accommodating grooves having a recess shape open toward an inner side in a radial direction and extend in a circumferential direction, at a plurality of positions in an axial direction.

4. The wire harness according to claim 2, wherein the inner circumferential surface portion of the splicing terminal includes soft brazing material accommodating grooves having a recess shape open toward an inner side in a radial direction and extend in a circumferential direction, at a plurality of positions in an axial direction.

5. A method for manufacturing a wire harness, comprising steps of;
preparing a plurality of coated electric wires having a plurality of exposed conductor portions obtained by removing portions of coatings, a heat-shrinkable tube that is long enough to accommodate the plurality of exposed conductor portions, a splicing terminal having a substantially tubular shape that can connect the plurality of exposed conductor portions, and a soft brazing material in a paste form with which voids between the splicing terminal and the plurality of exposed conductor portions can be filled and that melts at a melting point lower than a heat resistance temperature of the coatings of the plurality of coated electric wires;
holding the splicing terminal integrally in the heat-shrinkable tube by shrinking a portion of the heat-shrinkable tube;
filling voids between the splicing terminal and the plurality of exposed conductor portions with the soft brazing material by adhering an amount of the soft brazing material to at least one out of an inner circumferential surface portion of the splicing terminal that is integrally held in the heat-shrinkable tube and the plurality of exposed conductor portions, and then inserting the plurality of exposed conductor portions and end portions of the coatings of the plurality of coated electric wires into the splicing terminal integrally held in the heat-shrinkable tube, the end portions being adjacent to the exposed conductor portions; and
heating the heat-shrinkable tube and the inside of the heat-shrinkable tube from outside of the heat-shrinkable tube to thermally shrink the heat-shrinkable tube and to form a connecting member having a closed-ended tubular shape using the splicing terminal and the soft brazing material, the connecting member accommodating the plurality of exposed conductor portions, while also connecting the splicing terminal and the plurality of exposed conductor portions via the soft brazing material.
